(19) United States
(12) Patent Application Publication
(10) Pub. No.: US 2005/0232179 A1
(43) Pub. Date: Oct. 20, 2005

(54) Multiple-radio mission critical wireless mesh networks

(76) Inventors: Francis daCosta, San Jose, CA (US); Sriram Dyanandan, San Jose, CA (US)

Correspondence Address: FRANCIS daCOSTA;c/o MESHDYNAMICS, SUITE 400, 2953 BUNKER HILL LANE, SANTA CLARA, CA, 95054, US

(21) Appl. No.: 11/084,330

(22) Filed: Mar. 17, 2005

Related U.S. Application Data
(63) Continuation-in-part of application No. 10/434,948, filed on May 8, 2003.
(60) Provisional application No. 60/554,246, filed on Mar. 17, 2004.

(51) Int. Cl. H04J 1/10; H04J 3/08; H04B 7/14; H04Q 7/24; H04J 3/24

(52) U.S. Cl. 370/315; 370/338; 370/349

(57) ABSTRACT

An approach using 2 logical radios to achieve high performance in multihop mesh networks is introduced. The advantages of frequency re-use, reduced channel interference over 1 radio approaches is discussed. An approach is developed to extend the logical 2-radio system to (physical) 3-radio and 4-radio systems are explained as extensions of the logical 2-radio methodology. The ability need to support both multiple radio systems and 1-radio ad hoc mesh systems in one framework is described in the context of emergency response systems. Some unique benefits of the logical 2-Radio concept related to other mesh architectures are highlighted.

### CROSS-REFERENCE

This application is a continuation-in-part of application of U.S. application Ser. No. 10/434,948, filed May 8, 2003, which is herein incorporated by reference. This application also incorporates by reference U.S. Provisional Application No. 60/554,246, filed Mar. 17, 2004.

Also incorporated by reference are Disclosure Documents numbers 548927, 548966, and 548734 which were all filed on Mar. 16, 2004 under the USPTO Disclosure Document program. Separate letters have been attached to this application requesting that the referenced Disclosure Documents be retained for future reference.

### FIELD OF THE INVENTION

The present application builds on the disclosures or the referenced previous applications. In the referenced patent applications, a method to change the network topology by employing multiple radios is described in U.S. application Ser. No. 10/434,948, filed May 8, 2003 in FIGS. 1,2,3,4,5,6,7,8.

FIG. 18 in that same application depicts a two-radio mesh network, with one radio for the backhaul and another servicing clients and providing the backhaul to other nodes of the network. Extensions of the logical two-radio approach include 3 and 4 radios.

The logical two-radio approach depicted in FIG. 18 in that application shows two types of radio interfaces—one to the backhaul above the node and the other servicing the backhaul below it. The invention described in this document relates to how the two-radio approach is extensible to other radio configurations required to support mission critical mesh networks.

### BACKGROUND OF THE INVENTION

There is increasing interest in employing one network to support video, voice and data traffic. Currently, the video, voice and data networks are distinct since each addresses differing latency and bandwidth requirements. The challenge lies in providing—within the same network—the ability to address potentially conflicting latency and throughput needs of diverse applications.

For example, voice needs to be transmitted with low delay (latency). Occasionally lost voice packets, while undesirable, is not fatal for voice transmissions. Conversely, data transmissions mandate delivery of all packets and while low latency is desirable it is not essential. In essence transmission across the wireless network should (ideally) be driven by the needs of the application.

Building a reliable wireless network comes with other constraints specific to wireless. Some routing paths may be best for voice, others for data. In Wired LAN applications separate routing paths is more easily accomplished since each port on the LAN is connected to one client machine. Each node may be configured to provide the performance characteristics required by that application. If all computing devices were wired, each could have different Quality of Service (QoS) settings.

This level of granularity is not possible in wireless networks. Radio is a shared medium. It is prone to interference from other radio transmissions in the vicinity. A direct repercussion of radio interference is that a separate Access Point (AP) for each client machine is not practical. An AP can interfere with other APs and there are not enough non-interfering channels to go around. Further, while each additional radio may increase bandwidth capacity, it may also cause more interference between radios—perhaps even reducing the overall capacity of the network Controlling Network Topology. The challenge lies in enabling each Access Point node to support differing application requirements and ensuring that the aggregate demand of each Access Point be addressed without an appreciable loss in performance for individual clients. Additionally, if the network configuration needs to change then changes to network topology must occur in a stable and scalable manner.

Aggregate demand may be expressed as a range of acceptable latency and throughput values. Note that latency and throughput are often conflicting objectives. Low latency (least number of hops) may cause low throughput. High throughput may require increased latency.

In the patent application Ser. No. 10/434,948, filed May 8, 2003, a method to change the network topology by employing multiple radios is described and the changes in mesh topology is illustrated by FIGS. 1,2,3,4,5,6,7,8. in that application. FIG. 1 in this application briefly shows how the latency/throughput gradually changes with network topology.

FIG. 1 is made up of four individual sections, labeled 1 through 4. In each of these sections, the main area shows a number of radio devices configured in a specific mesh topology. The radio devices are part of the backhaul—each of them is therefore both an Access Point (AP) and a bridge to the backhaul, through other APs. Each node in the figure represents a 2-radio system where one interface is “down” providing connectivity to client stations and other APs connecting to the backhaul through it. The second radio provides the backhaul path “up” to the wired backbone.

The AP/bridge connected to the wired backbone is labeled, the “Root”. (There is only one root in this topology, though that is not a requirement. All that is required is that the number of root be greater than or equal to one.) The other nodes must transmit their packets to the root in order to have them placed onto the wire. The solid lines between nodes and the root represent the mesh topology.

Each of the four sections also is labeled with the “Backhaul throughput”—which for the simulation is measured as a inverse relationship to proximity. The relationship between throughput and proximity is modeled as in inverse square law based on experimental data. The curve is shown in the lower left hand corner of section 4 in FIG. 2. The simulation environment includes the ability to change the throughput-distance relationship for differing radios and wireless cards.

Each section is also labeled with the “backhaul number of hops”, which represents the average number of hops that a packet in that network will have to make in order to reach the root. The sections should be examined beginning in the upper left, and proceeding clockwise. The important results are:
In section 1, the network is configured in order to optimize latency, that is, in order to minimize the total number of hops that packets will need to make. All nodes transmit their packets directly to the root. However, of all the possible configurations this has the lowest total throughput, because some of this one-hop links will be of low data rate due to physical separation between the nodes.
In section 2, a tradeoff is starting to be made between latency (hops) and throughput. As the network is directed to emphasize throughput, it begins to make changes to the topology such that a larger number of hops is used in order to make sure that each mesh connection is at a higher data rate. A single change has been made in this case, as shown by the solid red line. Data from this node must now pass through an intervening node before reaching the root.
Section 3 shows even more of an emphasis on throughput, with an additional node now using a two hop path to the root, and the throughput rate increasing from 55 to 59.
Section 4 shows a mesh topology with a high emphasis on throughput, less on latency. Five of the nodes are now using two hop paths to reach the route, increasing the throughput to 64, but increasing to latency as well, since the average number of hops is now 1.6

Logical 2-Radio Mesh Backhauls The network topology control system described in U.S. application Ser. No. 10/434,948, filed May 8, 2003 is based on a 2-Radio system shown in FIG. 18 in that application and included as FIG. 4 in this application. There are two radios in each mesh node, for the uplink and downlink support. Radio 010 is upward facing and connects to the downlink (labeled 020) of its parent radio. Thus, a chain of connectivity is formed as shown by labels 040-050-060. In addition to providing a chain of connectivity, the downward facing radios (020) also provide connectivity to clients (such as laptops) shown as triangles. One such client is labeled 030.

There is a cloud surrounding each mesh node. This is the coverage area of the radio signal for the downward facing radio. They are colored differently to depict that each is operating on a different channel than other radios in its vicinity. Thus each radio belongs to a different Basic Service Set (BSS) or sub domain of the network. As such the system resembles a wired network switch stack. A wired network switch stack also has a similar tree structure with similar uplinks, and downlink connections. See FIG. 4. Labels 040-050-060 form a functionally identical chain of connectivity. Also, each switch in a network switch stack operates on a separate sub-domain of the network.

Why Logical 2-Radio Mesh Backhauls are Needed. There are serious bandwidth degradation effects related to single radio mesh networks. The LHS diagram on FIG. 2 depicts a typical 2 radio mesh network. One radio (010) provides services to clients while another radio (020) is part of an Ad Hoc Mesh—where all radios are operating on the same channel as depicted by the same color clouds (030)

In contrast FIG. 2 RHS depicts a logical 2-Radio where each mesh radio (025) is part of a distinct sub domain of the network, depicted by different color clouds (035).

Returning to the LHS of FIG. 2, all the backhaul radios (020) are on the same channel and thus are all part of the same network. In essence they form the wireless equivalent of a hub.

Hubs are not scalable because there is too much interference between all the members of the hub as the hub becomes larger. Exactly the same problem exists with conventional mesh networks. After 1-2 hops the co-channel interference between the mesh nodes (020) no longer allow high bandwidth transmissions.

There is another issue with single radio mesh backhauls are not scalable. There is bandwidth degradation with each hop—typically 50% per hop with single radio mesh backhauls. Refer to FIG. 3. On the left hand side is a single radio backhaul. If it is part of a relay path then every packet it receives must be re-transmitted on the same radio: Label 010. This with each hop the effective throughput reduces by 50% from the previous hop. This makes bandwidth available at the end of the 3^{rd} hop ⅛ of the available bandwidth. This is unacceptable for high performance requirements in either enterprise infrastructure networks or mission critical application requirements e.g. emergency response systems.

On the RHS FIG. 3, Labeled 020, there are two radios—one to receive data and another to re-transmit. Now, the effective throughput is not compromised because there are two radio, operating on non-interfering channels. Simultaneous send and receive is now possible.

Single radio mesh backhauls do not present a scalable solution to addressing high bandwidth requirements for a mission critical mesh network.

### SUMMARY OF THE INVENTION

Accordingly, there exists a need to support the performance requirements of mission critical mesh networks in multihop situations. FIG. 4 shows the infrastructure mesh in a topology with a 2-radio unit in a multiple hop wireless network. The rectangular icons in this figure represent the APs, which have formed a mesh in order to support clients. The triangular icons represent these clients. At the top of the figure are the root Access Points or APs (two, in this example) that have a direct connection to the wired backbone. Each of these APs creates a separate BSS using a separate RF channel.

The BSSs (Basic Service Sets) are labeled as BSS [hops], [index], so BSS 1,1 indicates that this is the first BSS for which one hop is needed to reach the wired backbone. For the non-root APs, one radio serves as an AP to its clients; the other radio acts as a backhaul.

The radio interface colored green—labeled 010—acts as a connection to the “Parent”—the backhaul. It operates in station mode: it appears as a client, no different from other clients shown as triangles. The backhaul and AP radio, colored gray—labeled 020—operates in AP mode: it services clients, including other Access Points accessing it as clients, through their second radio operating in station mode. In the lower layers, a description such as BSS 2,3 means that this is the third AP for which two hops are required to reach the wire. Triangles denote client radios (see Label 030).

Radio is a shared medium where only one device can be “talking” at a time. As networks grow, performance degrades rapidly as the same AP services more clients. The AP's BSS becomes unmanageable. The need to split up the network into smaller groups becomes essential to the health of a network.

A classic solution is to split up the wireless network into smaller groups (BSS), each of which is operating on a non-interfering channel with other groups (BSS). Simultaneous “conversations” are now possible in each BSS. This solution, however, is not available in an ad-hoc (peer-to-peer) mesh solution, because such a solution must, by definition, create a single, large, BSS.

Each BSS shown in the infrastructure mesh of FIG. 4, however, is not interfering with other transmission channels allocated to neighboring BSSs. Channel Interference is contained and spatial re-use is possible. Two-radio solutions are therefore more impervious to noise than their 1-radio counterparts. Channels can automatically be re-allocated to avoid unpredictable sources of interference such as radar or unauthorized transmissions that may be present in emergency or military situations.

The Logical 2-Radio Concept is distinct from conventional Mesh. The Logical 2-Radio concept must not be confused with other mesh approaches that may also use 2 (or more) physical radios. This is referred to as a “Dual-radio” mesh and shown on the LHS of FIG. 2.

FIG. 2, LHS shows that one radio services client while the other forms an ad hoc mesh. Separating the service from the backhaul improves performance when compared with conventional ad hoc mesh networks. But a single radio ad hoc mesh is still servicing the backhaul—since only one radio communicates as part of the mesh. Packets traveling toward the Internet share bandwidth at each hop along the backhaul path with other interfering mesh backhauls—all-operating on the same channel.

Such systems are not scalable since the backhaul is still as single radio and suffers from the bandwidth degradation with each hop, endemic to single radio backhauls, see FIG. 2 label 010. In contrast, the Logical 2-Radio concept described in this document focuses on a multiple radio backhaul as shown in FIG. 3, Label 020.

It should also be noted that regardless of the number of radios allocated to the backhaul and those allocated in service of clients, the system resembles a wired switch stack from a logical perspective. Other mesh architectures resemble a hub.

Adding more Physical Radio: The logical 2 radio approach forms a tree like network as shown in FIG. 4. One radio provides the uplink to a parent radio and another the downlink to child nodes. Thus the 2-Radio mesh node labeled 040 is a parent to mesh Node labeled 050. The mesh Node labeled 050 is a parent to mesh node labeled 060.

Mesh node labeled 050 also has two client radios, shown as triangles, one of which is labeled 030. Lack of a separate radio to service clients limits the effective backhaul bandwidth for the network, since clients are sharing bandwidth on the backhaul. It also prevents the use of proprietary but more efficient transmission protocols on the radios, since those radios also have to “talk” with client radios, that demand a non-proprietary and less efficient protocol.

An extension of the logical 2-radio functionality is to use three radios with two separate radios for the (high speed) backhaul and one more radio for separate (slower) service to clients. Refer to FIG. 6. Again we see the familiar tree like structure. But this time the two backhauls are dedicated radios (labels 010, 020) and there is a separate radio (025) to service clients (030) only. The chain of connectivity (040-050-060) has not changed.

Note that while more (physical) radios have been employed, FIGS. 5 and 6 are functionally identical. In both cases, one the functionality of uplink and downlink are separate. In FIG. 5, the downlink supports both client and mesh nodes. In FIG. 6, the radio (020) providing downlink connectivity is now dedicated to backhaul services while another radio (025) services clients (0300. There is performance improvement of shifting the slower traffic from clients to another radio so the backhaul can operate in the “fast lane” but beyond this implementation improvement FIG. 6 and FIG. 4 are functionally identical.

This invention addresses multiple embodiments of the logical 2 radio approach depicted in FIG. 4 provides solutions that address a variety of mesh networking applications. These embodiments are shown in FIGS. 5,6,7,8,9. Extensions to support voice and video in mission critical public safety networks are described in FIGS. 10, 11, 12. Lastly, this invention addresses how combining the logical radio embodiments may be dynamically reconfigured—in the field and on the fly—to support both infrastructure style mesh networks and conventional ad hoc mesh networks. Hybrid mesh networks for military & public safety applications are discussed and shown in FIGS. 13,14,15

### BRIEF DESCRIPTION OF DRAWINGS

In order to more fully describe embodiments of the present invention, reference is made to the accompanying drawings. These drawings are not to be considered limitations in the scope of the invention, but are merely illustrative.

FIG. 1 illustrates how the network topology is changed by selecting a different backhaul in a 2 radio system, with one link to the backhaul AP and the other link servicing the child AP. It depicts four network topologies. Each of the four network topologies provide a different set of performance in terms of latency and throughput. The mesh control software adjusts the latency and throughput parameters to meet voice/video or data performance requirements in terms of latency and bandwidth.

FIG. 2 contrasts the conventional “Dual Radio” mesh with the Logical 2-Radio Mesh. On the LHS of FIG. 2, 2 radios labeled 010 and 020 provide client connectivity and ad hoc mesh backhaul functionality, respectively. All the mesh backhaul radios (020) are on the same channel depicted by the clouds of coverage of the same color (030). There are all part of the same sub-network. In contrast, on the RHS of FIG. 2, the same radio (025) provides service to clients and also backhaul functionality but operates in different sub domains depicted by different color clouds of coverage (035). The LHS resembles a “hub”, the RHS a “switch”. Hubs are not scalable.

FIG. 3 compares the 2 step process of a single radio relay to a 2-radio relay. On the left side, (010) a single radio relay is shown. Every packet received has to be re-transmitted on the same radio. Thus the bandwidth with every hop in a single radio mesh network is reduced by approximately 50%. After 3 hops, the Bandwidth would be ⅛ of what is available at the Ethernet backhaul. On the RHS (020) a 2-radio backhaul is shown, where packets received on one radio are re-transmitted on another radio operating on a non-interfering channel. Now there is no bandwidth reduction with every hop and bandwidth is preserved with every hop. Two radio mesh backhauls are thus scalable while single radio backhauls are not.

FIG. 4 shows how the structure of 2-radio multiple hop mesh network where each 2 radio unit services a Basic Service Set (BSS) by configuring one of the two radios to serve as an AP to its clients. Clients may include the second radio of another 2 radio system, with this radio configured to run in station mode, providing the backhaul path back to the Ethernet link. In the insert, the uplink radio (labeled 010) connects to the parent mesh node while the downlink radio (labeled 020) acts like an Access Point to client radios, including other mesh nodes that connect to it through their uplink radio. Note that all service radios (020) operate on different non-interfering channels, depicted by different color ovals.

FIG. 5 shows the similarities between FIG. 4 and a wired switch stack with the same chain of connectivity 040-050-060. Both have the same tree-like structure and up link and down link connections. In both cases the units (040,050,060) operate on a distinct sub domain.

FIG. 6 illustrates one embodiment of the two logical radio approach with 3 physical radios. Two radios constitute logically one radio of the two logical radio concept, while the third physical radio serves clients as the second radio of the two logical radio concept. By eliminating the sharing of physical radios for both backhaul and client services, the backhaul bandwidth has improved and also reduced the dependency to use the same type of radios for the backhaul and the client. In the insert, the uplink radio (labeled 010) connects to the parent mesh node while the downlink radio (labeled 020) connects to the uplink radio of child mesh nodes. The service radio (labeled 030) act as Access Points to client radios shown as triangles. One such is labeled 040. Note that all service radios (030) operate on different non-interfering channels, depicted by different color ovals.

FIG. 7 illustrates another embodiment of the two logical radio approach but with 5 physical radios. The uplink and downlink radios (shown as one radio FIG. 6) is now split into two radios, each responsible for one direction of traffic. Bandwidth is doubled and latency halved, since traffic in the opposing direction now has its own “lane”. Thus, the radio labeled 010 in FIG. 6 is now radios 012 and 010. Similarly, the radio marked 020 in FIG. 6 is now split into radios labeled 022 and 020. The radio pairs 012-010 and 022-020 provide the same functionality as the radios labeled 010 and 020 in FIG. 6 but with twice the bandwidth and approx half the latency.

FIG. 8 is an extension of the 5-radio embodiment shown in FIG. 7. In FIG. 7, there is one service radio to service both voice and data customers. However voice and data traffic has different performance requirements. Data requires higher bandwidth and is relatively indifferent to latency. Conversely, voice requires low bandwidth but is latency sensitive. By having different Access Point radios service the voice and data clients), the contention between voice and data packets attempting to gain access to the same medium is reduced. Also, with different radios servicing the data and voice clients, the voice and data packets can now be treated differently. The Access Point radios servicing the voice clients could therefore be operating in TDMA (time division multiple access) mode while the AP radio servicing the data clients operates in CSMA (Collision Sense Multiple Access) mode. The two radios (032) and (034) thus provide different functionality. Phones connect to the former, laptops to the latter.

FIG. 9 is a 5-Radio extension of the 3-Radio configuration shown in FIG. 6 but with more dedicated service radios operating on different frequencies for different types of client radios.

FIG. 10 shows the maximum VOIP bandwidth available per client, using 802.11 radios, as the number of clients increase. This is the size of the packet that each client can send every 20 ms. As the number of clients increase the size of the packet—and the associated voice quality—drops dramatically. For a 64 Kbps voice quality, a 802.11b radio can support around 25 clients.

FIG. 11 shows the maximum VOIP bandwidth available per client, using 802.11a radios, as the number of clients increase. This is the size of the packet that each client can send every 20 ms. As the number of clients increase the size of the packet—and the associated voice quality—drops dramatically. For a 64 Kbps voice quality, an 802.11a radio can support around 55 clients

FIG. 12 shows extensions developed and implemented in the mesh network stack to provide an efficient backhaul for voice. The small voice packets are concatenated into larger packets and sent (as one packet) at regular intervals to the backhaul radios. At each mesh node voice packets intended for that destination are removed and the rest sent back (as one large packet).

Salient portions include the Packet classifier (labeled 010) that recognizes voice packets based on size and regularity of transmissions, the VOIP concatenation engine (labeled 020) that “container-izes” small voice packets into a larger “container” packet for more efficient transportation, Real time extensions (labeled 030) to the Linux kernel enable the system to provide near real time performance regarding sending and receiving the latency sensitive VOIP container packets through the network—regardless of what the Operating System is doing at the time.

FIG. 13 shows the concept of a “Hybrid Mesh network” where 2 radio systems provide two types of service. In one case, they are part of an infrastructure mesh as shown by the 2-radio mesh node labeled 010. In another case, the same node may be dynamically reconfigured to support ad hoc peer-to-peer connectivity. The node labeled 020 (marked as E8) has two radios. One is intended for client radio connection to infrastructure mesh nodes—see the radio labeled 030 on the unit marked E9. The other provides a peer-to-peer mesh capability, as shown by radio labeled 040. Depending on the needs of the network, the 2-radio units are dynamically re-configured to support either need, infrastructure mesh (010) or backhaul support to ad hoc mesh (020). Labels 050 and 060 mark connected and broken ad hoc mesh links.

FIG. 14 is an application of the Hybrid Mesh concept to Public Safety. The node labeled 010 is a Stationary node on top of a light pole. A mobile version shown as labeled 020 is entering the building (arrow). These mobile units are also called “breadcrumb” routers. The Mobile Mesh nodes provide connectivity to 2-Radio portable units worn by the firemen in this picture. All Firemen are thus connected to themselves through a peer-to-peer mesh network shown as a thin red line. They are also connected to the Infrastructure mesh backhaul through one or more connect points. This ensures redundancy in network connectivity. The broken link (labeled 060, FIG. 13) is avoided.

FIG. 15 is an application of the Hybrid Mesh concept related to Battle Force Protection.

FIG. 18 shows how the installation software is tagged to both the radios and board characteristics. It shows a serial line connected to load the boot loader program, after which the Ethernet port is used to complete the software installation and branding process. Compiling the install program on the board it is intended to run on does this, thus creating a unique software image.

FIG. 19 is a screen dump of the Flash Deployment software developed and implemented to ensure that software generated for the install of this board cannot be used by another mesh node. When the software installation process begins, the software is compiled on the board it is intended for and the compilation process is unique since it is based on a number of unique factors. The software is generated on the board—that it is intended to run on—to ensure that the software image cannot be used to run on another board, thus preventing both software privacy and dissuading theft of the mesh nodes.

FIG. 20 shows that the Mesh Control Software sits above the Media Access Control (MAC) of the radio. As such it is Radio and Protocol agnostic.

FIG. 21 shows how channel interference is dynamically managed in the logical 2-Radio system.

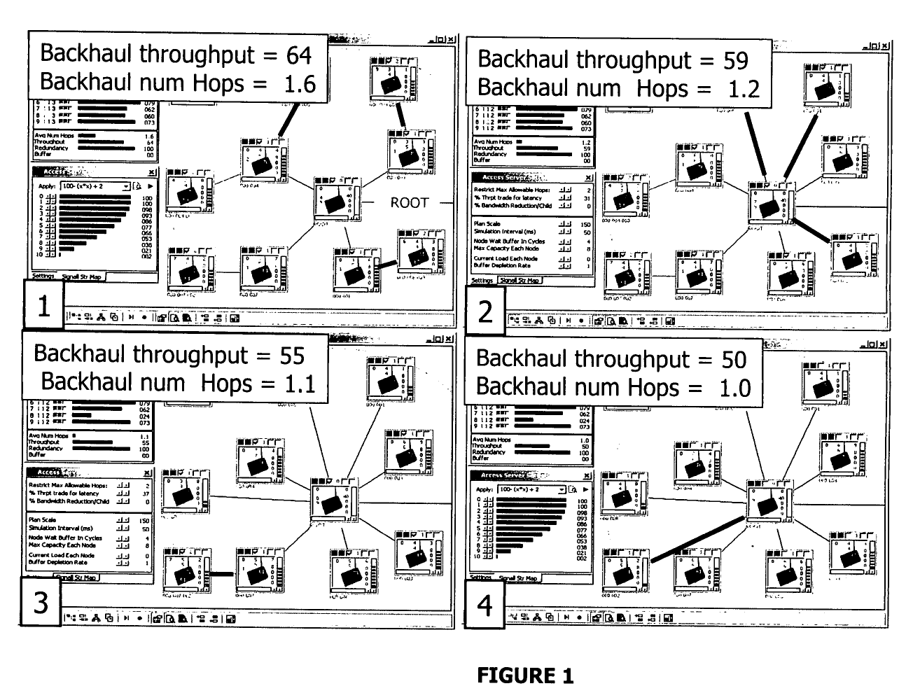

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

Radio is a shared medium where only one person can be “talking” at a time. As networks grow, performance degrades rapidly as more clients are services by the same AP. The AP's Basic Service Set (BSS) becomes unmanageable. The need to split up the network into smaller groups is essential to the health of a network.

The problem is exacerbated in multi-hop topologies using one-radio systems. With one-radio units everyone is on the same BSS—bandwidth is reduced to half with each successive hop in the network. The reason is that radio is a shared medium—every one has to stay silent when a re-transmission from one hop to another hop (within the same BSS) occurs. One radio networking solutions cannot meet are the high performance requirements of enterprise infrastructure networks.

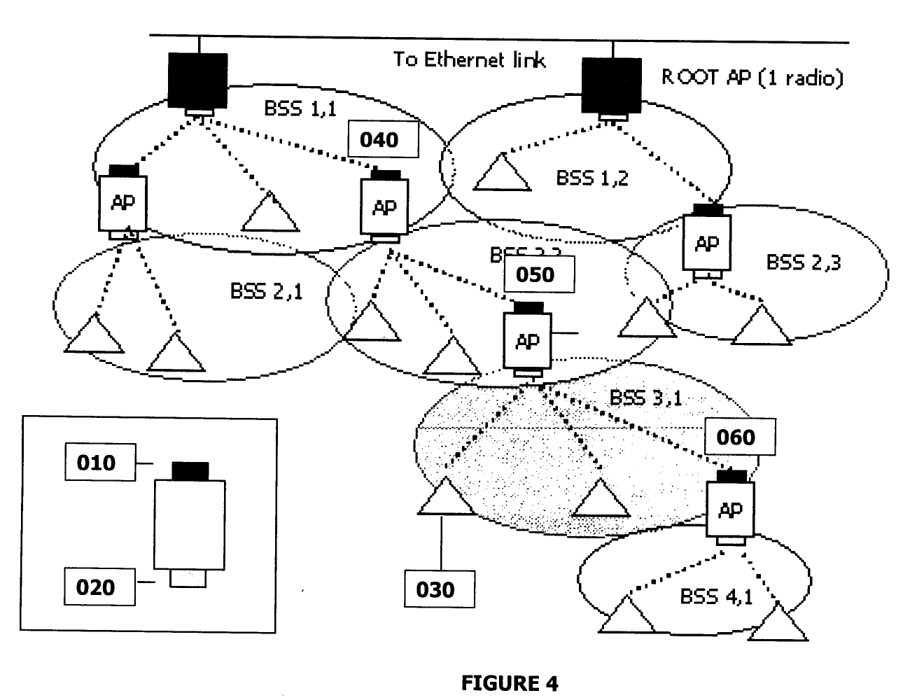

Our solution is to split up the wireless network into smaller groups (BSS), each of which is operating on a non-interfering channel with other groups (BSS). Simultaneous “conversations” are now possible. Each BSS shown above is not interfering with other transmission channels allocated to neighboring BSSs. But to do this and provide bridging across the individual sub networks, requires 2 radios as shown in FIG. 4 (label 020)

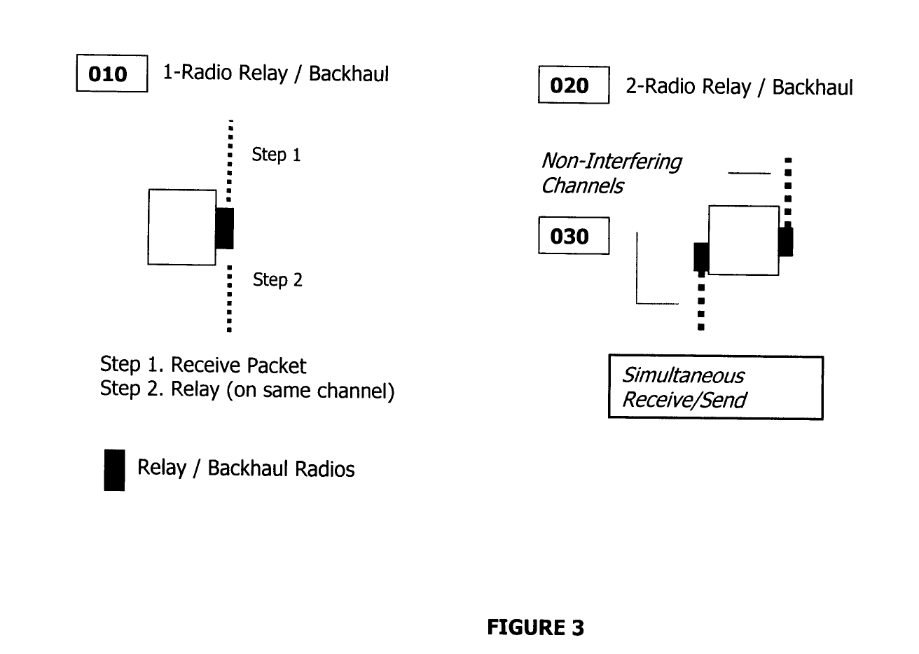

FIG. 3 compares the performance of a single radio relay (or backhaul) to that of a 2-radio relay (or backhaul) On the LHS, (010) a single radio relay is shown. Every packet received has to be re-transmitted on the same radio. Thus the bandwidth with every hop in a single radio mesh network is reduced by approximately 50%. After 3 hops, the Bandwidth would be ⅛ of what is available at the Ethernet backhaul. In contrast On the RHS (020) a 2-radio backhaul is shown, where packets received on one radio are re-transmitted on another radio operating on a non-interfering channel. This is depicted as the different color for the dashed lines emanating from the radios. (030)

Since the radios operate on different channels, they are now part of separate sub-networks. Transmissions from one do not affect the other and both can transmit/receive freely. With the radios operating on different non-interfering channels, there is now no bandwidth reduction with every hop. Bandwidth is preserved with every hop. Two radio mesh backhauls are thus scalable while single radio backhauls are not. This is in essence the power of the 2-Radio concept: separating the uplink and down link radios in a mesh network.

FIG. 4 shows the infrastructure mesh in a topology with a 2-radio unit in a multiple hop wireless network. The rectangular icons in this figure represent the APs, which have formed a mesh in order to support clients. The triangular icons represent these clients. At the top of the figure are the root Access Points or APs (two, in this example) that have a direct connection to the wired backbone. Each of these APs creates a separate BSS using a separate RF channel.

The BSSs (Basic Service Sets) are labeled as BSS [hops], [index], so BSS 1,1 indicates that this is the first BSS for which one hop is needed to reach the wired backbone. For the non-root APs, one radio serves as an AP to its clients; the other radio acts as a backhaul.

The radio interface colored green—labeled 010—acts as a connection to the “Parent”—the backhaul. It operates in station mode: it appears as a client, no different from other clients shown as triangles. The backhaul and AP radio, colored gray—labeled 020—operates in AP mode: it services clients, including other Access Points accessing it as clients, through their second radio operating in station mode. In the lower layers, a description such as BSS 2,3 means that this is the third AP for which two hops are required to reach the wire. Triangles denote client radios (see Label 030).

Radio is a shared medium where only one device can be “talking” at a time. As networks grow, performance degrades rapidly as the same AP services more clients. The AP's BSS becomes unmanageable. The need to split up the network into smaller groups becomes essential to the health of a network.

A classic solution is to split up the wireless network into smaller groups (BSS), each of which is operating on a non-interfering channel with other groups (BSS). Simultaneous “conversations” are now possible in each BSS. This solution, however, is not available in an ad-hoc (peer-to-peer) mesh solution, because such a solution must, by definition, create a single, large, BSS.

Each BSS shown in the infrastructure mesh of FIG. 4, however, is not interfering with other transmission channels allocated to neighboring BSSs. Channel Interference is contained and spatial re-use is possible. Two-radio solutions are therefore more impervious to noise than their 1-radio counterparts. Channels can automatically be re-allocated to avoid unpredictable sources of interference such as radar or unauthorized transmissions that may be present in emergency or military situations.

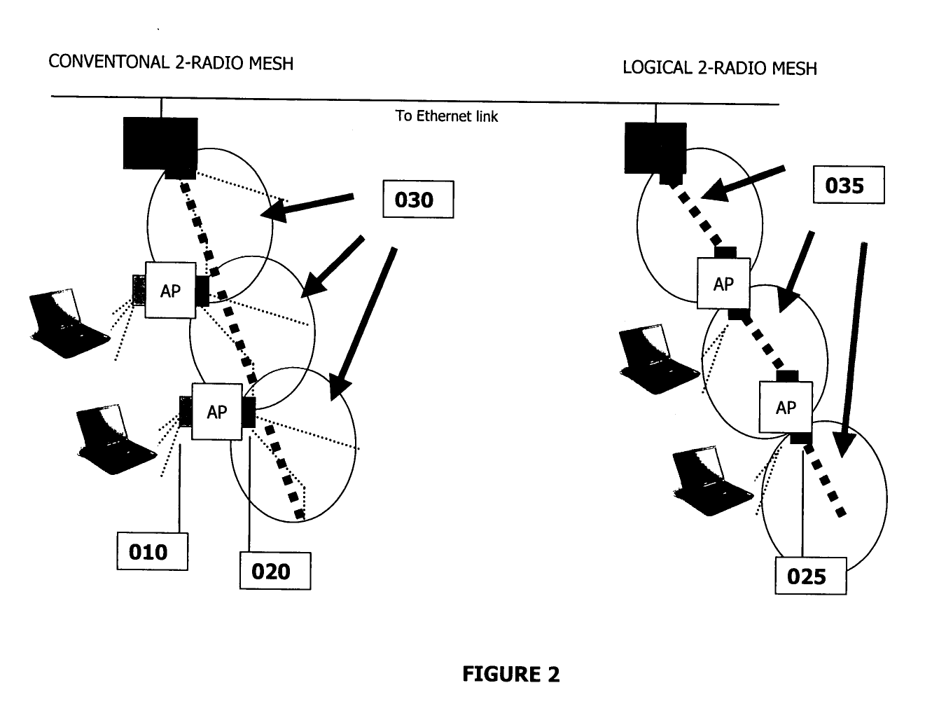

The Logical 2-Radio Concept is distinct from conventional Mesh. The Logical 2-Radio concept must not be confused with other mesh approaches that may also use 2 (or more) physical radios. This is referred to as a “Dual-radio” mesh and shown on the LHS of FIG. 2.

FIG. 2, LHS shows that one radio services client while the other forms an ad hoc mesh. Separating the service from the backhaul improves performance when compared with conventional ad hoc mesh networks. But a single radio ad hoc mesh is still servicing the backhaul—since only one radio communicates as part of the mesh. Packets traveling toward the Internet share bandwidth at each hop along the backhaul path with other interfering mesh backhauls—all-operating on the same channel.

Such systems are not scalable since the backhaul is still as single radio and suffers from the bandwidth degradation with each hop, endemic to single radio backhauls, see FIG. 2 label 010. In contrast, the Logical 2-Radio concept described in this document focuses on a multiple radio backhaul as shown in FIG. 3, Label 020.

It should also be noted that regardless of the number of radios allocated to the backhaul and those allocated in service of clients, the system resembles a wired switch stack from a logical perspective. Other mesh architectures resemble a hub.

Adding more Physical Radio: The logical 2 radio approach forms a tree like network as shown in FIG. 4. One radio provides the uplink to a parent radio and another the downlink to child nodes. Thus the 2-Radio mesh node labeled 040 is a parent to mesh Node labeled 050. The mesh Node labeled 050 is a parent to mesh node labeled 060.

Mesh node labeled 050 also has two client radios, shown as triangles, one of which is labeled 030. Lack of a separate radio to service clients limits the effective backhaul bandwidth for the network, since clients are sharing bandwidth on the backhaul. It also prevents the use of proprietary but more efficient transmission protocols on the radios, since those radios also have to “talk” with client radios, that demand a non-proprietary and less efficient protocol.

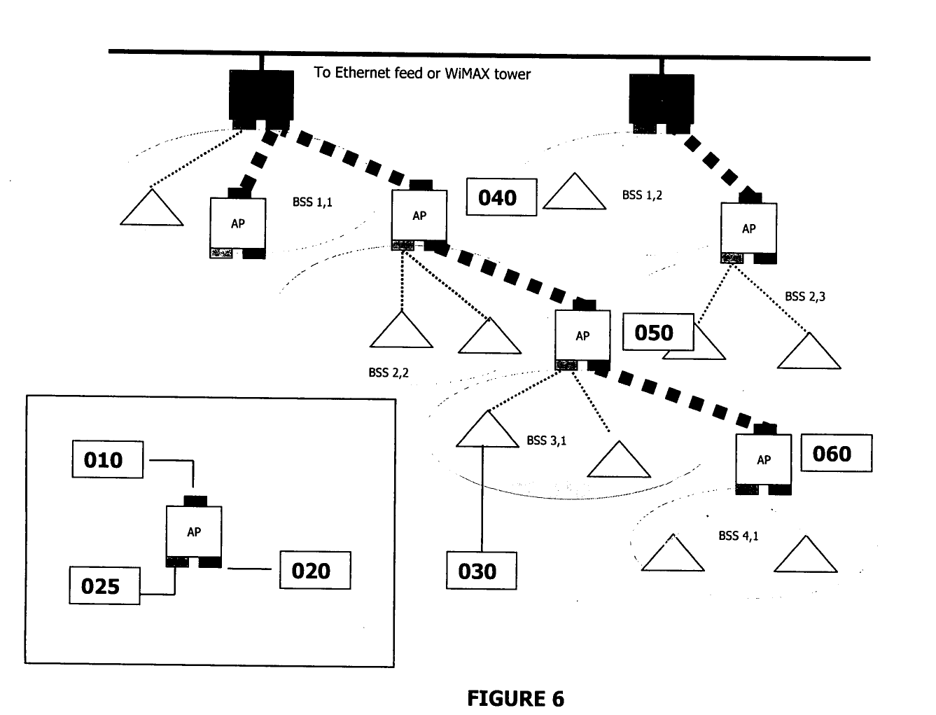

An extension of the logical 2-radio functionality is to use three radios with two separate radios for the (high speed) backhaul and one more radio for separate (slower) service to clients. Refer to FIG. 6. Again we see the familiar tree like structure. But this time the two backhauls are dedicated radios (labels 010, 020) and there is a separate radio (025) to service clients (030) only. The chain of connectivity (040-050-060) has not changed.

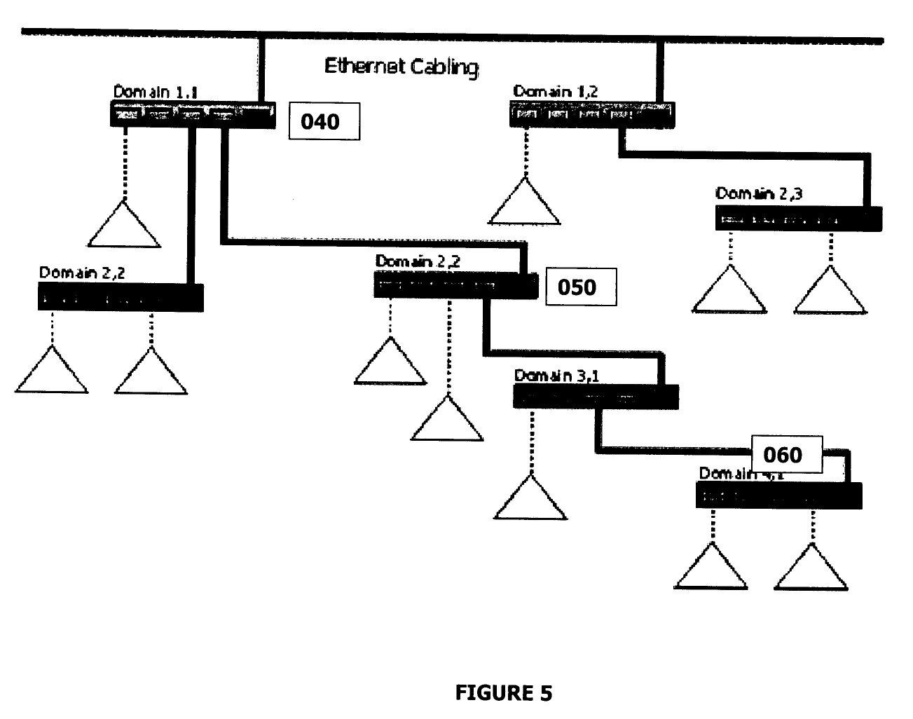

Note that while more (physical) radios have been employed, FIGS. 5 and 6 are functionally identical. In both cases, one the functionality of uplink and downlink are separate. In FIG. 5, the downlink supports both client and mesh nodes. In FIG. 6, the radio (020) providing downlink connectivity is now dedicated to backhaul services while another radio (025) services clients (0300. There is performance improvement of shifting the slower traffic from clients to another radio so the backhaul can operate in the “fast lane” but beyond this implementation improvement FIG. 6 and FIG. 4 are functionally identical.

Adding more Physical Radios to the Backhaul. In FIG. 6 the logical service radio was split into 2 Physical radios to achieve greater performance. The logical backhaul radio can also be split into multiple backhaul radios to provide better backhaul. More backhaul radios provides more alternate routing paths and the ability to tune individual routing paths to support required application settings. Thus it is possible to have multiple backhauls, one that provides low latency (with fewer hops) and another that provides more throughput but using a more circuitous route with more hops and more latency.

The system would then route packets such that Voice packets traveled along the low latency backhaul and data packets would travel on the other—high throughput—backhaul. Adding more backhauls thus increases flexibility in supporting diverse performance requirements and also improves redundancy and fault tolerance. Note however, that from a logical perspective, this is still a 2-Radio system depicted in FIG. 5 and the software control layer that manages the multiple backhaul system is functionally the same as that for the 2-Radio units.

Full Duplex Backhauls A variation of this concept of adding more physical radios in support of better backhaul functionality is to split the incoming and outgoing traffic to two separate backhaul radios. This doubles the bandwidth and effectively reduces latency also.

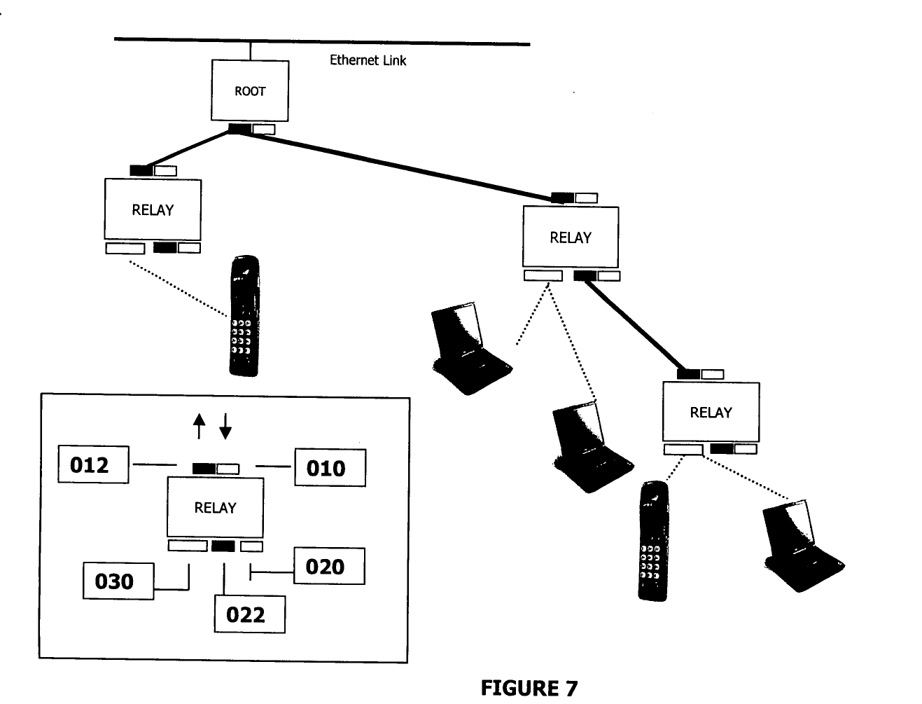

In FIG. 7 the uplink and downlink radios (shown as one radio FIG. 6) is now split into two radios, each responsible for one direction of traffic. Bandwidth is doubled and latency halved, since traffic in the opposing direction now has its own “lane”. Thus, the radio labeled 010 in FIG. 6 is now radios 012 and 010. Similarly, the radio marked 020 in FIG. 6 is now split into radios labeled 022 and 020. The radio pairs 012-010 and 022-020 provide the same functionality as the radios labeled 010 and 020 in FIG. 6 but with twice the bandwidth and approx half the latency.

Multiple Service Radios A single radio must service all local clients, regardless of the application requirements. Consider an Access Point servicing both Voice over IP (VOIP) and data clients If a number of data devices are requesting simultaneous transfers, they will interfere with voice traffic, thereby adding significant latency and jitter. Latency and jitter are enemies of VoIP, and this situation rapidly results in deteriorated call quality. Since radio is a shared medium, the only way to prevent this interference is at the source of the problem—the shared spectrum at the radio. By the time the data and voice traffic get to a wireless backhaul it's too late. The damage has already been done.

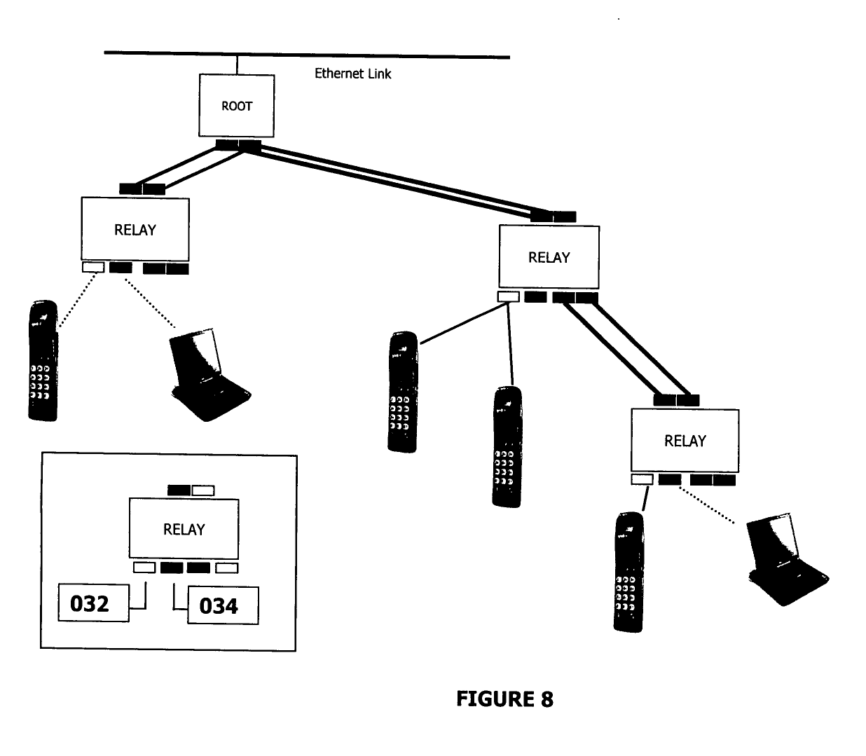

FIG. 8 is an extension of the 5-radio configuration shown in FIG. 7 to separate voice and data traffic. In FIG. 7, there is one service radio to service both voice and data customers. However voice and data traffic has different performance requirements. Data requires higher bandwidth and is relatively indifferent to latency. Conversely, voice requires low bandwidth but is latency sensitive. By having different Access Point radios service the voice and data clients), the contention between voice and data packets attempting to gain access to the same medium is reduced. Also, with different radios servicing the data and voice clients, the voice and data packets can now be treated differently. For example, the radio servicing voice clients could therefore be operating in a different mode such as PCF (Point Control Function) or TDMA (time division multiple access) mode while the AP radio servicing the data clients operates in DCF (Distributed Control Function) mode.

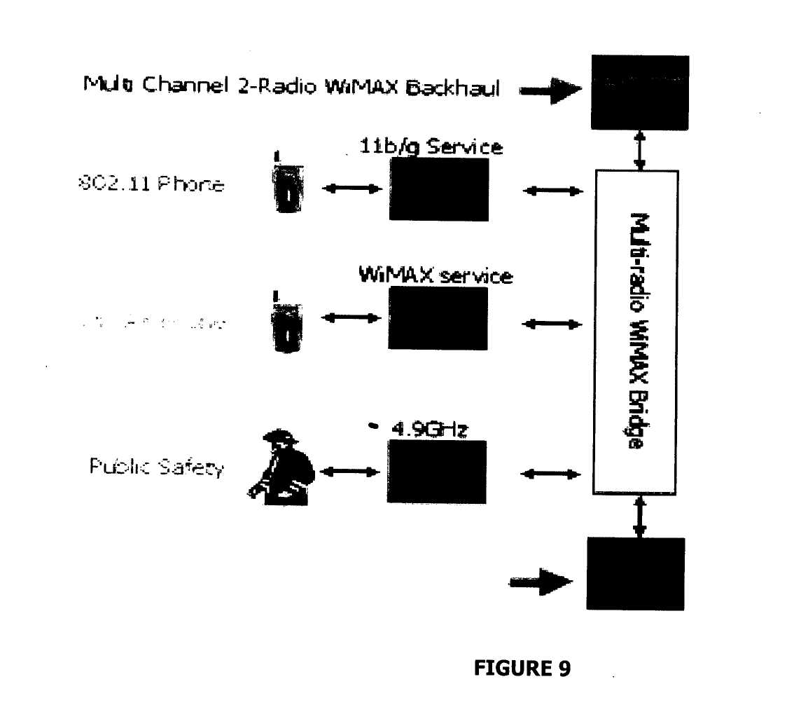

Along the lines of multiple service radios, FIG. 9 is a 5-Radio extension of the 3-Radio configuration shown in FIG. 6 but with more dedicated service radios operating on different frequencies for different types of client radios. The backhaul is WiMAX and it supports WIFI, WIMAX and public safety (4.9 GHZ) service radios.

The logical 2-radio concept must not be confused with “dual radio” mesh. In all the configurations outlined above, it should be noted that—regardless of the number of radios allocated to the backhaul and those allocated in servicing clients—the system is functionally identical to the logical two-radio shown in FIG. 4.

It must also be noted that the logical 2-Radio concept contrasts with what is referred to as “Dual radio” or “1+1” mesh. For example some mesh companies use what is referred to in the industry as a “1+1” mesh or “dual-radio” mesh. See FIG. 2 LHS. Here one radio services client while the other forms an ad hoc mesh. Separating the service from the backhaul improves performance when compared with conventional ad hoc mesh networks. But a single radio ad hoc mesh is still servicing the backhaul—since only one radio communicates as part of the mesh. Packets traveling toward the Internet share bandwidth at each hop along the backhaul path with other interfering mesh backhauls—all-operating on the same channel.

Such systems are not scalable since the backhaul is still as single radio and suffers from the bandwidth degradation with each hop, endemic to single radio backhauls, see FIG. 4 label 010. In contrast, the Logical 2-Radio concept described in this document focuses on a multiple radio backhaul as shown in FIG. 2 RHS.

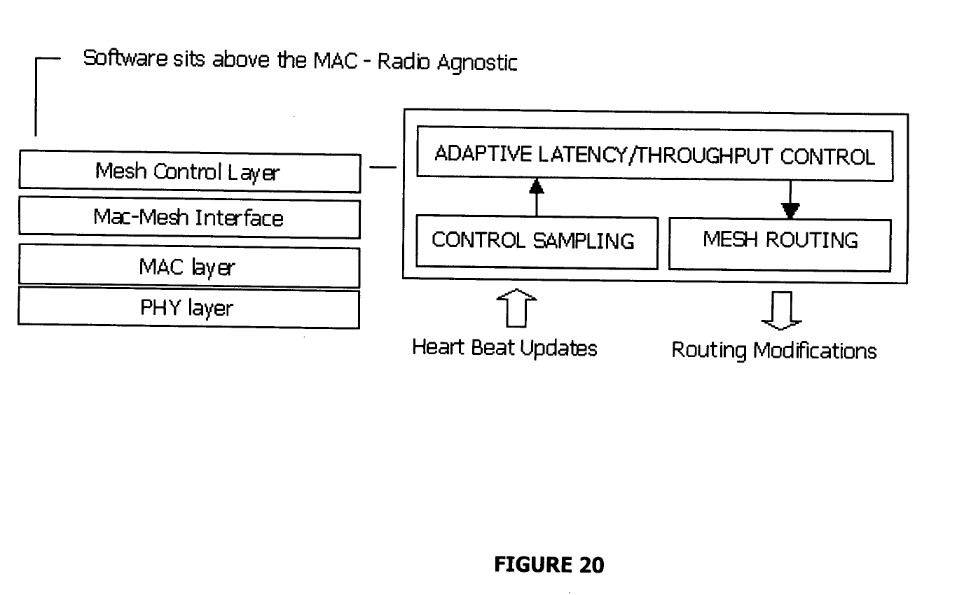

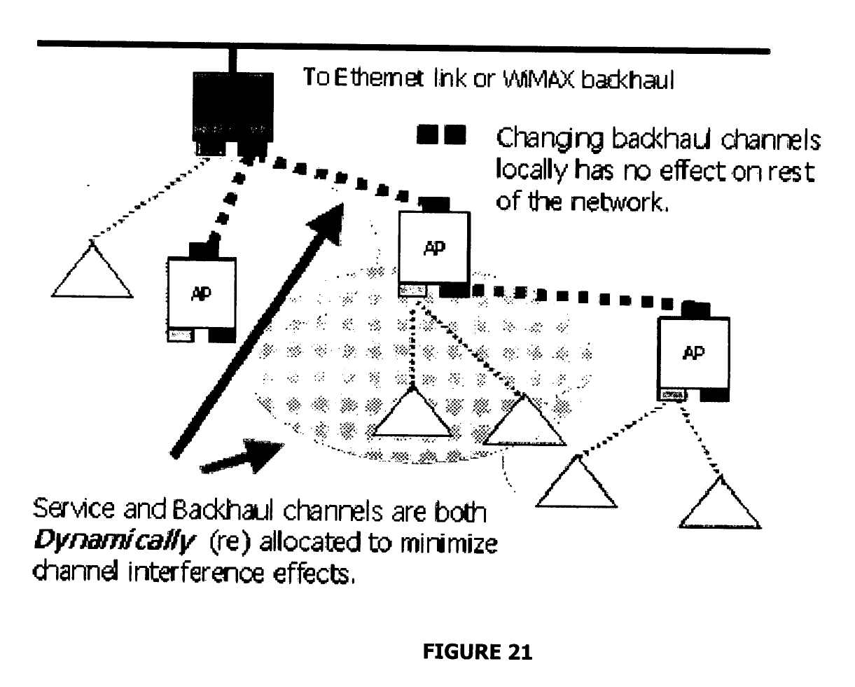

Other distinctive benefits of the Logical 2-Radio approach (vs.other approaches) include:
Layer 2 routing is radio and protocol agnostic. The mesh control layer operates just above the MAC layer of the radio. It functions as a layer 2 bridge between backhaul and service radios. L3 functionality is thus unaffected. Thus Network/Security functionality is unaffected by our Layer 2 software. FIG. 20 shows that the Mesh Control Software sits above the Media Access Control (MAC) of the radio. As such it is Radio and Protocol agnostic.
Faster Routing Updates. The tree like structure (See FIGS. 5,6,7) engenders a faster routing mechanism than conventional ad hoc mesh. Hence enterprise class wired network switch stacks use an efficient tree structure for routing. Ad hoc Mesh manages a large routing table, generally Order(n²). In contrast, the tree like structure is Order (n) and both system overhead and reaction time are lower.
Manages Channel Interference: In 1-radio systems, all radios on the backhaul share the same channel. They are easily affected by interference—possibly malicious—on their operating channel. With Logical 2-Radio mesh, nodes can switch to other channels to avoid channel interference from near by nodes operating in another segment of the network. See FIG. 21.
Dynamic Re-configurability: The logical 2-radio approach requires a minimum of 2 physical radios (See FIG. 4) but there are no upper bounds. Thus is a radio “dies”, the system automatically shifts down to a more appropriate configuration. This may affect performance but functionally the system architecture has not changed. This level of redundancy is impossible in conventional mesh architectures. See FIG. 2, LHS. The radios 010 and 020 are serving distinct purposes and are generally of different types. For example the radio servicing clients (010) is typically a 802.11b/g radio while the radio part of the backhaul (020) is generally an 802.11a radio. If one radio dies, the other cannot be easily re-configured to support the dead radio functionality without compromising its original purpose. Such is NOT the case with the Logical 2-Radio approach because both radios are of the same time in order to form the chain link 040-050-060 shown in FIGS. 4, 5, 6.

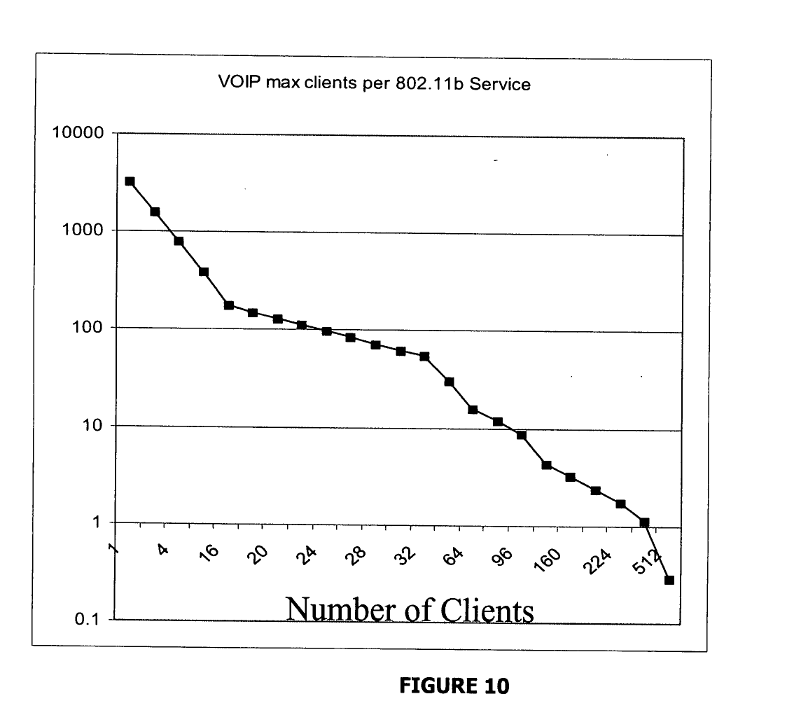

VOIP Extension For Mesh Backhauls. FIG. 10 shows the maximum VOIP bandwidth available per client, using 802.11 radios, as the number of clients increase. This is the size of the packet that each client can send every 20 ms. As the number of clients increase the size of the packet—and the associated voice quality—drops dramatically. For a 64 Kbps voice quality, a 802.11b radio can support around 25 clients.

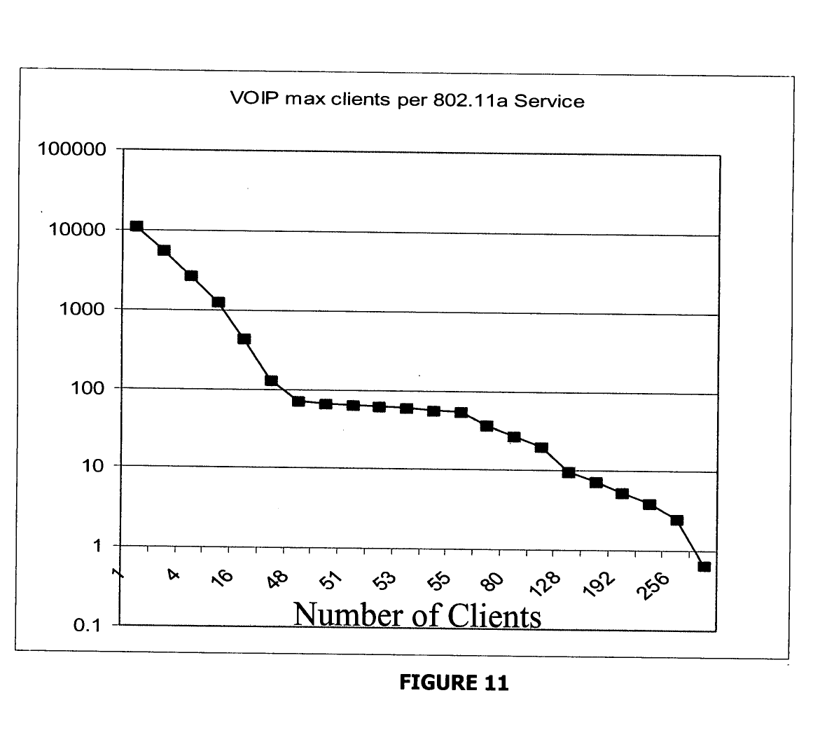

FIG. 11 shows the maximum VOIP bandwidth available per client, using 802.11a radios, as the number of clients increase. This is the size of the packet that each client can send every 20 ms. As the number of clients increase the size of the packet—and the associated voice quality—drops dramatically. For a 64 Kbps voice quality, an 802.11a radio can support around 55 clients

The point is that regardless of the type of service radio selected, the maximum clients that can be supported per radio is around 50. That implies that in the case of the chain 040-050-060 shown in FIG. 6, the total number of VOIP clients to be supported by the backhaul would be around 150. Since the radio cannot support more than 50, other steps must be taken so that the relay/backhaul radios are not the bottleneck.

The inefficiencies of transmitting voice packets are largely due to their small size and frequency of transmission. The Radio protocol commonly employed is CSMA/CA based (Collision Sense Multiple Access/Collision Avoidance) and it becomes increasingly inefficient as the size of the packet reduces. The challenge, therefore, is to container-ize the packets so voice packets become part of large container (for more efficient transportation) but at the same time not delay sending the packets in order to “fill” the container.

As an analogy, the bus can wait a little while longer at a bus station to pick up more passengers but if it waits too long, it will miss its scheduled arrival that the next stop—to the chagrin of passengers expects to disembark there.

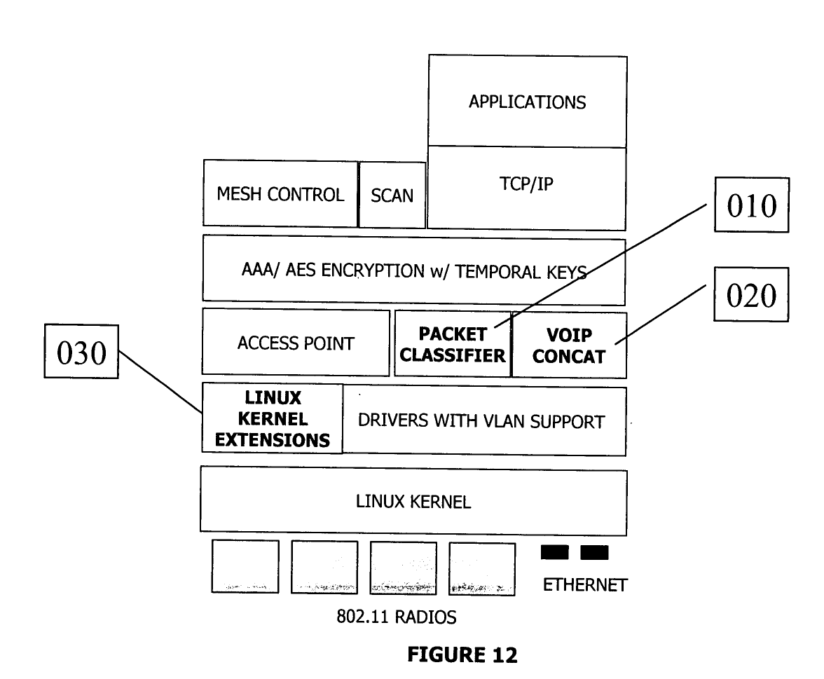

FIG. 12 shows extensions developed and implemented in the mesh network stack to provide an efficient—yet time sensitive—backhaul for voice. The small voice packets are concatenated into larger packets and sent (as one packet) at regular intervals to the backhaul radios. At each mesh node voice packets intended for that destination are removed and the rest sent back (as one large packet). The real time extensions (030) ensure that the delivery is made according to regular intervals—regardless of what else the operating system is doing at the time. Salient portions include the Packet classifier (labeled 010) that recognizes voice packets based on size and regularity of transmissions, the VOIP concatenation engine (labeled 020) that “container-izes” small voice packets into a larger “container” packet for more efficient transportation, Real time extensions (labeled 030) to the Linux kernel enable the system to provide near real time performance regarding sending and receiving the latency sensitive VOIP container packets through the network—regardless of what the Operating System is doing at the time.

Hybrid Mesh Networks. One-radio mesh networking solutions are inferior to multiple radio solutions in multihop situations. In the case of 1 radio systems available bandwidth is reduced by 50% with each hop: the bandwidth available at the 3rd hop is ⅛ of the available capacity. Conversely, 2-radio infrastructure mesh solutions are ideal for multihop situations—with no restrictions on the number of hops. They are also more reliable since the AP is intended to be stationary and therefore provide dependable service in its coverage area. But they are not intended for peer-to-peer connectivity in standard 802.11 modes of operation. In standard 802.11, radios are either configured to act as an AP, a STA or in ad hoc mode.

Mission critical applications (e.g. emergency response) need high bandwidth—regardless of how many hops you are away from the backbone—to be able to download maps or upload video. They must also be assured of connectivity at all times—every node must be able to route traffic to all other nodes in the network.

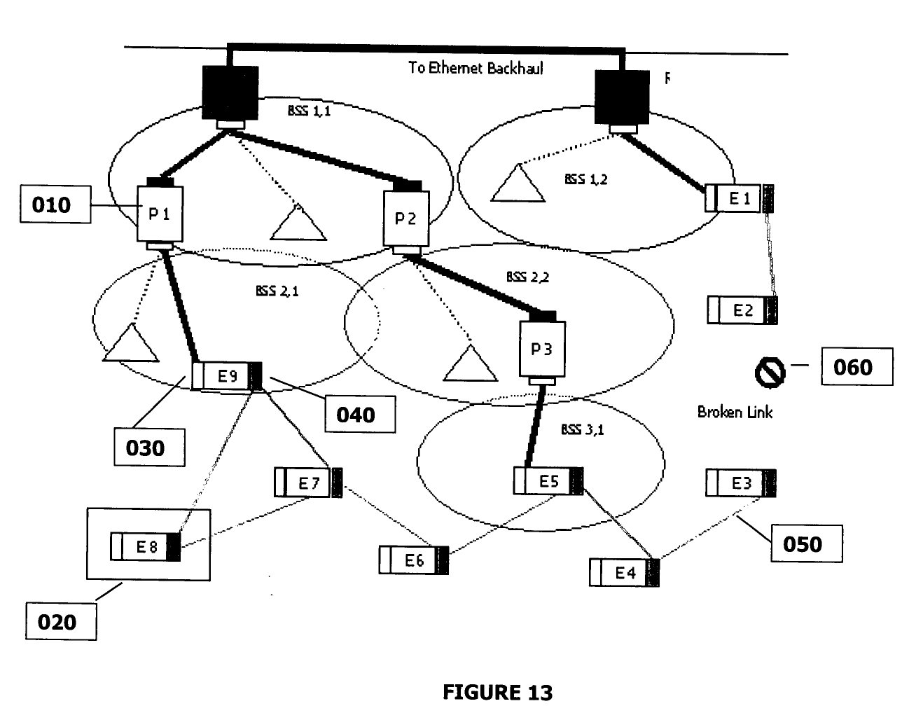

Infrastructure backhaul addresses robust connectivity. Infrastructure backhaul is also needed to support ad-hoc mesh networking. In FIG. 13, the ad hoc wireless link between E2 and E3 has been lost due, say, to excessive distance or an intervening obstruction—typical of dynamic, uncertain or hostile environments. With no 2-radio backhaul support, Nodes E1 and E2 are stranded, that is, they have no way of communicating with the other mobile radio units, at least in ad-hoc mode. The backhaul link now becomes their lifeline. Two-radio portable backhauls are thus essential in emergency response systems where the team may be scattered over large areas, and yet not made up of a very high number of actual devices.

A single radio ad hoc mesh is not sufficient, since all E nodes are intended to be mobile, their movement cannot be restricted to operate within coverage from another E unit. Further, redundant routing configurations (E7-E8-E9) cannot be assured, and the string of pearls pattern (E3-E4-E5-E6-E7) is too tenuous a connectivity chain for mission critical applications.

Hybrid mesh topologies are for situations where one radio mobile ad hoc network connectivity (for peer-to-peer connectivity) combined with two radio infrastructure backhaul support provides the best of both worlds: ubiquitous connectivity with multiple levels of redundancy. To simplify production issues, the 2-radio Portable backhaul and mobile units can be the same hardware but dynamically configured to operate differently.

The backhaul radios can be dynamically configured to have one radio in AP mode and the other is STA mode. The 2 radio mobile units are configured to have one radio in STA mode (to talk to the backhaul) with another radio in ad hoc mode to talk with peers. Either unit can fill in for the other—changes are software based and dvnamically configurable. This favors economies of scale—the same hardware services both peer-to-peer and infrastructure requirements. Also, in the general case, most nodes would be of the 2-Radio configuration shown in FIG. 4. In the event the node reaches the edge of a network and has to support ad hoc mesh (E1-E2-E3-E4) it will dynamically reconfigure itself to become a Hybrid node. Thus Node E1 could have been a 2-Radio unit but it would dynamically reconfigure itself to support the connectivity requirements of E2 thar has been stranded because of a broken link with E3 (label 060, FIG. 13).

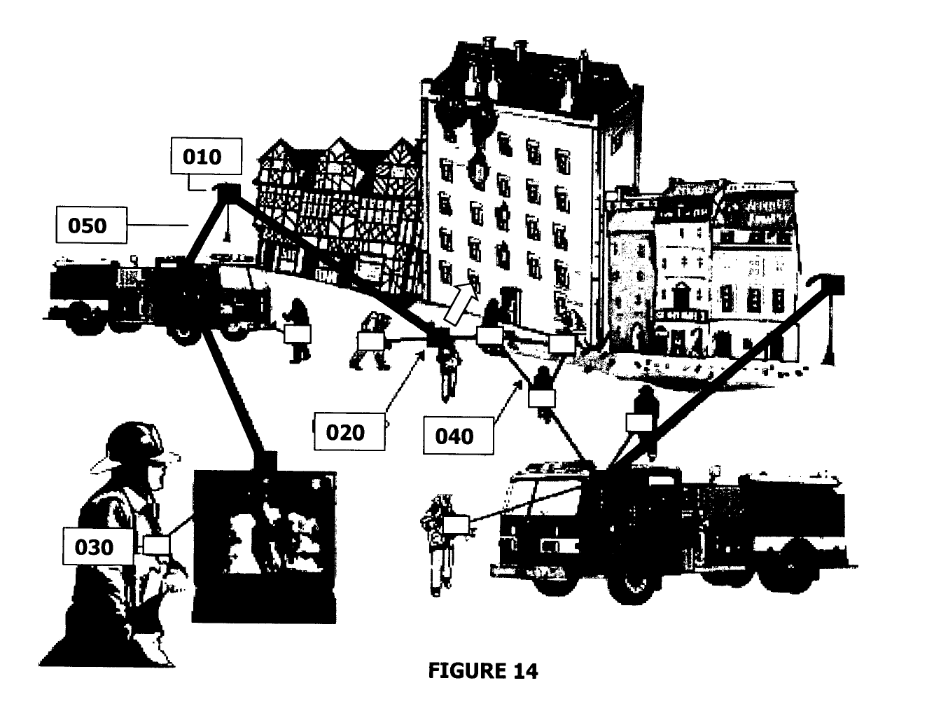

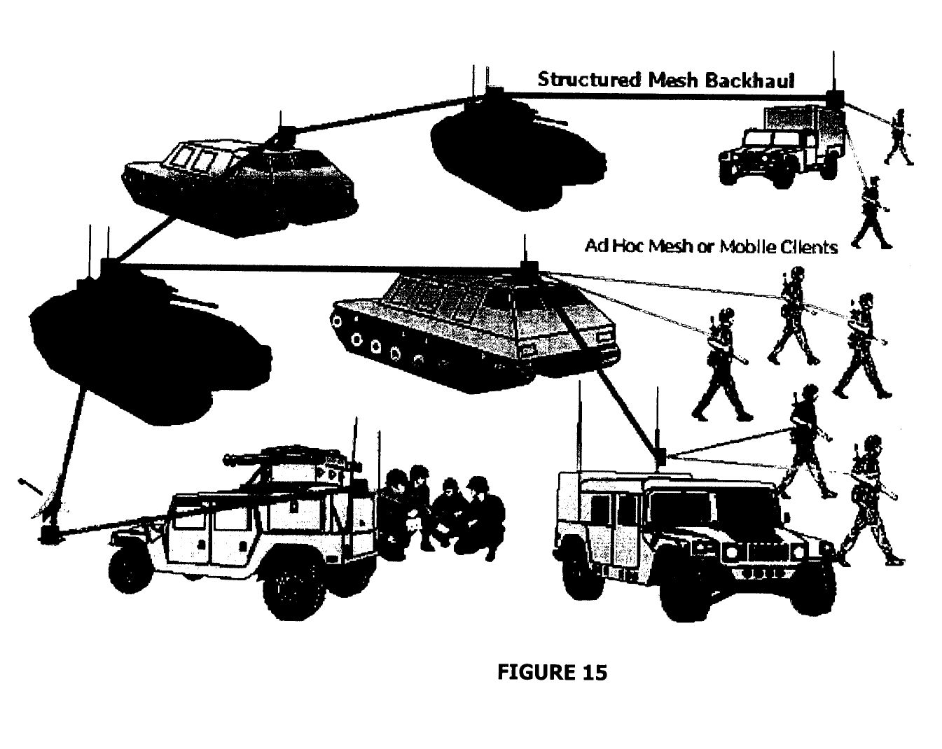

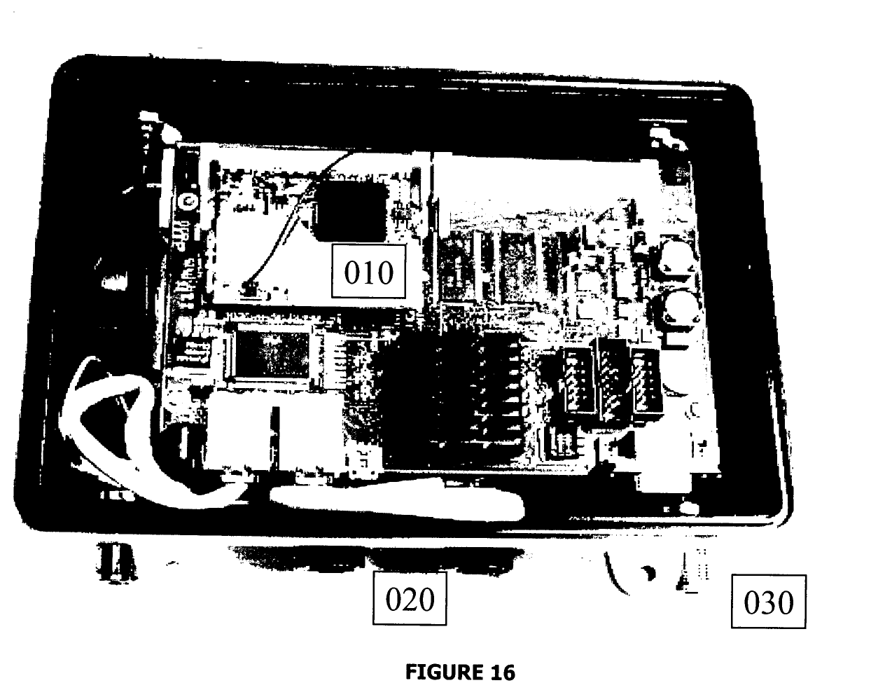

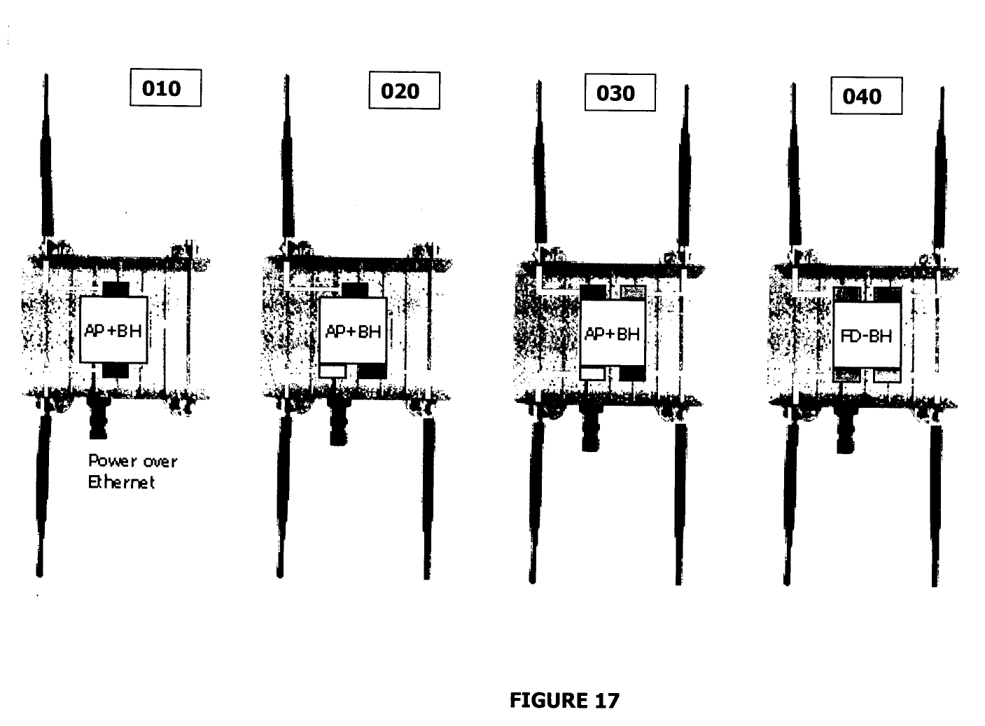

FIG. 14 is an application of the Hybrid Mesh concept to Public Safety. The node labeled 010 is a Stationary node on top of a light pole. A mobile version shown as labeled 020 is entering the building (arrow). These mobile units are also called “breadcrumb” routers. The Mobile Mesh nodes provide connectivity to 2-Radio portable units worn by the firemen in this picture. All Firemen are thus connected to themselves through a peer-to-peer mesh network shown as a thin red line. They are also connected to the Infrastructure mesh backhaul through one or more connect points. This ensures redundancy in network connectivity. The broken link (labeled 060, FIG. 13) is avoided. FIG. 15 is a similar application of the Hybrid Mesh concept but related to Battle Force Protection.

Mobility Extensions for moving mesh nodes. An enhancement to the 3-Radio module is to add a 4th radio as a scanning radio. The scanning radio monitors the environment and the other radios on the mesh node to ensure that the radio-antenna subsystems are functioning correctly. They also monitor the performance of neighboring mesh nodes and when a node malfunctions, scanning radios provide diagnostic information to the Network Management System (NMS).

Recall that in the 2-Logical Radio concept, all radios are operating on non-interfering frequencies to preserve bandwidth (see FIGS. 2,3) and thus cannot monitor each other. An external scanning radio is also needed to gauge the signal strength of a prospective parent node before the backhaul/relay path can decide that that node could provide better service. In lightly loaded situations, the radios can perform this scanning themselves with no loss in performance. In heavily loaded situations or in the event of a disaster, scanning would result in loss in performance.

Without a separate scanning, radio the NMS and adjoining nodes still know when a node goes down because control system heartbeats (sent on one channel and re-transmitted on another by a parent node) are not received. However only an external sensing radio can determine if there has been a mechanical failure—as a break in the cable. In the event of such malfunctions, scanning radios can dynamically reconfigure themselves to assume the functionality of the damaged unit. In short, scanning radios mesh form “buddy” relationships (as in police teams) to monitor and “cover” each other. Scanning radios are critical in dynamic environments—where mesh nodes are mounted on cars and the mesh topology is rapidly changing. These include public safety and battlefield scenarios.

Additionally scanning radios can provide information on client movement. If two mesh nodes are both in the vicinity of a moving client radio, then scanning radios on both nodes will pick up signals from the moving client radio. Now, as the client moves, its signal strength as received by one scanning radio will differ from that received by another. Based on the vector of motion, one mesh node will be better suited to servicing the client and a hand off from one mesh node to another may now be initiated in a proactive manner. Without the scanning radio, the hand off will still occur—but it will be because the client has lost connectivity and has to scan to find another mesh node to connect to. With some software on the client this break in connectivity may be avoided by informing the client when to switch to the next node. For a short while packets for the client will be sent to both nodes. Once the client shifts to the new node, the old node is informed. It then ceases to send packets and updates its routing table to delete the entry of the client as one of its clients.

Field Upgradeable Modular Design. A key advantage of the radio and protocol agnostic approach is that additional radios can be added to the system easily. The mesh control software emulates multiple port bridges and supports multiple input and output interfaces. There are no software limitations on the number of service radios or the number of backhaul radios supported. This ensures a cost effective long-term migration strategy supporting needs for more performance later.

FIG. 16 shows a production version of the 2-Logical radio system with support for up to 4 physical radios that can support a variety of configurations in a modular fashion. One radio is mounted (Label 010). There are a total of 4 such slots, two on top, two on the bottom. There are also two Ethernet ports (Label 020) with Power over Ethernet on one. Radios connect to one of 4 N-Female antenna connections (labeled 030).

FIG. 17 depicts some of the configurations possible with a 4 physical radio unit such as shown in FIG. 16. Based on the number of radio slots occupied, the system automatically configures itself to be a 2-Radio (FIG. 5), 3-Radio (FIG. 6) or a Full Duplex Backhaul (FIG. 7). The system is extensible. Through the Ethernet port, another 4 radio modular units may be added. Label 010 refers to the 2-radio configuration shown in FIG. 5. The label 020 refers to the 3-radio shown in FIG. 6. Label 030 refers to an extension of the 3-Radio system and discussed in more detail in this application. Label 040 refers to the Full Duplex 4 Radio system also shown in FIG. 7.

Theft protection of Mesh Nodes Mesh nodes are mounted in public spaces and open air locations, there must be means to dissuade theft. Theft is effectively controlled if the software on the mesh node cannot be copied and used on another mesh node. For that, the software running on the mesh node needs to have some unique, (copy proof) feature.

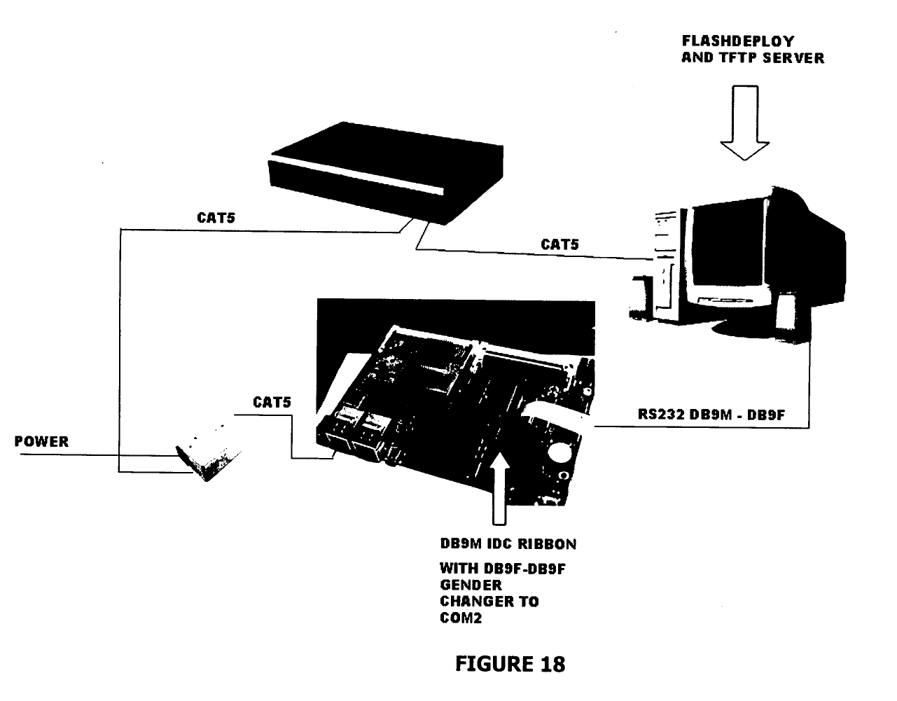

FIG. 18 shows the process developed and implemented for generating software tagged to the current radios and board characteristics. It shows a serial line connected to load the boot loader program, after which the Ethernet port is used to complete the software installation and branding process. Compiling the install program on the board it is intended to run on does this, thus creating a unique software image.

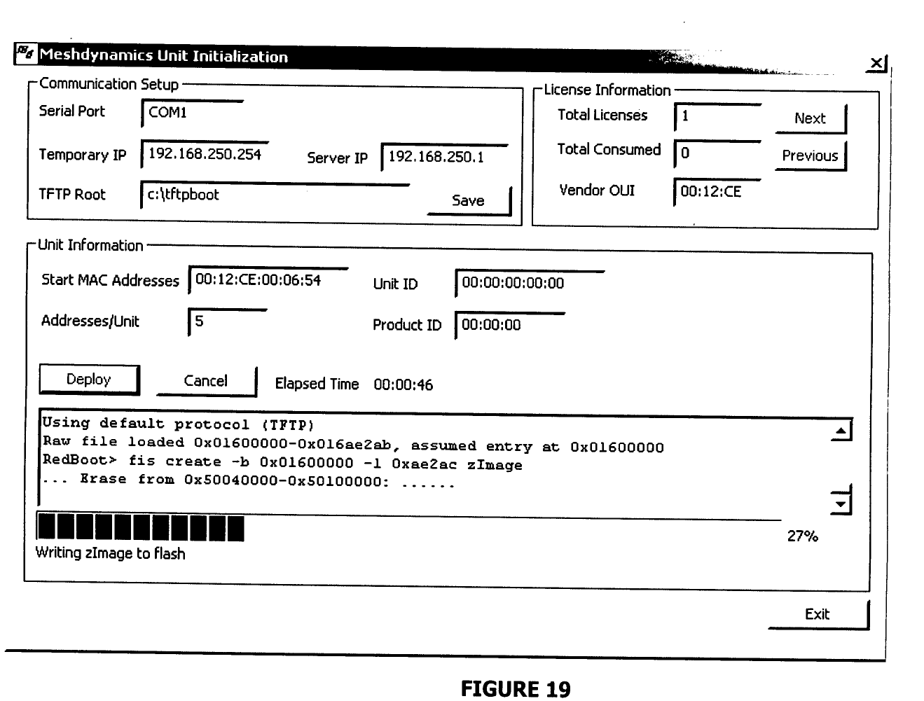

FIG. 19 is a screen dump of the Flash Deployment software developed and implemented to ensure that software generated for the install of this board cannot be used by another mesh node. When the software installation process begins, the software is compiled on the board it is intended for and the compilation process is unique since it is based on a number of unique factors. The software is generated on the board—that it is intended to run on—to ensure that the software image cannot be used to run on another board, thus preventing both software privacy and dissuading theft of the mesh nodes.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description, but rather is indicated by the appended claims. All changes that come within the meaning and range of equivalents within the claims are intended to be considered as being embraced within the spirit and scope of the claims which follow:

1. A wireless mesh network node containing at least two relay radios for performing a packet relay function, wherein;
a first relay radio can receive packets while a second relay radio simultaneously sends packets, and
wherein frequency channels for each relay radio are chosen automatically by a distributed software control layer that resides on each such mesh node in a mesh network, and which communicates with control layer software on other nodes in the mesh network.

2. The mesh network node of claim 1 also including one or more separate service radios which are connected to the relay radios via a software bridge.

3. The mesh network node of claim 2 where the separate service radios may differ from each other according to protocol or frequencies of operation.

4. A full duplex wireless mesh network node containing at least four relay radios for performing a packet relay function, wherein the following operations can occur simultaneously;
a first relay radio receives packets from a parent mesh node, and
a second relay radio sends packets to a parent mesh node, and
a third relay radio receives packets from a daughter mesh node, and
a second relay radio sends packets to a parent mesh node.

5. A wireless mesh network node containing at least two relay radios, and at least two service radios wherein at least one service radio is used exclusively for data traffic and at least one service radio is used exclusively for voice traffic.

6. A hybrid mesh network where some mesh nodes in the network have at least two relay radios and other mesh nodes have only one relay radio.

7. A wireless mesh network node containing at least two relay radios and at least three similar radios, where upon the failure of one relay radio, another relay radio can operate in place of the failed radio.

8. A wireless mesh network node optimized for VoIP traffic containing at least two relay radios including software that concatenates smaller voice packets into larger packets in order to increase the overall throughput of the mesh.

9. A wireless mesh network node containing at least two relay radios and a sensing radio such that the movement of another mesh node in a mesh network is observed by the sensing radio, and wherein said node communicates via the relay radios with other mesh nodes to control the packets transferred to and from the moving node such that packet transfer is not interrupted as the moving node dissociates and re-associates with other mesh nodes.
